(19) United States
(12) Patent Application Publication
(10) Pub. No.: US 2026/0091964 A1
(43) Pub. Date: Apr. 2, 2026

(54) STOWABLE DECK FOR AERIAL WORK PLATFORM

(71) Applicant: Oshkosh Corporation, Oshkosh, WI (US)

(72) Inventors: Zach Romanin, Oshkosh, WI (US); Jesse Sollers, Oshkosh, WI (US); Brandon Tucker, Oshkosh, WI (US)

(73) Assignee: Oshkosh Corporation, Oshkosh, WI (US)

(21) Appl. No.: 19/344,466

(22) Filed: Sep. 29, 2025

Related U.S. Application Data
(60) Provisional application No. 63/701,536, filed on Sep. 30, 2024.

(51) Int. Cl. B66F 11/04

(52) U.S. Cl. CPC B66F 11/04

(57) ABSTRACT

A platform for a lift device includes a base, a plurality of rails, and a deck. The plurality of rails at least partially surrounding the base. The deck is selectively coupled to the plurality of rails.

The deck is moveable between a storage position and a use position. The deck includes a front side opposite a back side, a first lateral side, and a second lateral side opposite the first lateral side. The lateral sides extend between the front side and the back side. The deck includes a locking mechanism configured to secure the deck in at least one of the storage position or the use position. In the storage position, the deck is substantially perpendicular with the base and in the use position, the deck is substantially parallel with the base.

### CROSS-REFERENCE TO RELATED PATENT APPLICATION

This application claims the benefit of and priority to U.S. Provisional Application No. 63/701,536, filed Sep. 30, 2024, the entire disclosure of which is incorporated by reference herein.

### BACKGROUND

The present disclosure relates to lift devices. More specifically, the present disclosure relates to a platform of a lift device.

### SUMMARY

One embodiment of the present disclosure is a platform for a lift device. The platform includes a base, a plurality of rails, and a deck. The plurality of rails at least partially surrounding the base. The deck is selectively coupled to the plurality of rails. The deck is moveable between a storage position and a use position. The deck includes a front side opposite a back side, a first lateral side, and a second lateral side opposite the first lateral side. The lateral sides extend between the front side and the back side. The deck includes a locking mechanism configured to secure the deck in at least one of the storage position or the use position. In the storage position, the deck is substantially perpendicular with the base and in the use position, the deck is substantially parallel with the base.

In some embodiments, the plurality of rails includes at least one handrail extending away from the base. The handrail includes an open end proximate the base and a closed end opposite the open end.

In some embodiments, the deck includes a pair of flanges coupled at each of the lateral sides proximate the back side of the deck and a pair of channels coupled to the base at the lateral sides of the deck, the channels configured to selectively receive the flanges. Moving the deck from the storage position to the use position includes translating the flanges within the channels in a vertical direction and pivoting the deck around an axis defined by a pair of spring pins.

In some embodiments, the locking mechanism includes a pair of spring pins, a cam, and a release rod. The pair of spring pins are at each of the lateral sides proximate the front side of the deck and moveable between an extended position and a retracted position. The cam is rotatably coupled to a bottom surface of the deck and coupled to each of the spring pins to move the spring pins between the extended and retracted positions. The release rod is coupled at one end to the cam and terminating in a release rod handle at an end of the release rod. In the retracted position, the deck is vertically translatable within the channels, and in the extended position, the spring pins are biased such that vertical translation of the deck is prevented. In some embodiments, the release rod is configured to rotate the cam to move the spring pins between the extended and the retracted positions. In some embodiments, in the extended position, the spring pins are retained in apertures and in the retracted position, the spring pins are withdrawn from the apertures. In some embodiments, the deck includes a handle proximate to the release rod handle and coupled to the back side of the deck.

In some embodiments, the platform includes an extendable rail assembly. The extendable rail assembly includes a plurality of guides coupled to the plurality of rails, a plurality of upright members extending within the plurality of guides away from the base, and a top rail extending between the plurality of upright members, wherein each of the plurality of upright members comprises at least one first aperture proximate an end of the plurality of upright members and at least one second aperture between the at least one first aperture and the top rail. The plurality of upright members and the top rail form a moveable rail assembly.

In some embodiments, the moveable rail assembly is moveable between a retracted position and one or more extended positions, and the extendable rail assembly includes a rail lock mechanism configured to secure the moveable rail assembly in the retracted position and the one or more extended positions. In some embodiments, the rail lock mechanism includes a second pair of spring pins coupled to the plurality of rails. When moving into the extended position, the second pair of spring pins automatically engage the at least one second aperture to lock the movable rail assembly in the extended position.

In some embodiments, the platform includes a gate rotatably coupled to at least one of the extendable rail assembly and moveable between an open position and a closed position, wherein in the closed position the top rail and the gate form a perimeter rail. In some embodiments, extendable rail assembly includes a first bracket rotably coupling a first end of the gate with the extendable rail assembly and a second bracket coupled with the extendable rail assembly and configured to support the gate, the second bracket including a pin. In some embodiments, moving the gate between the open position and the closed position includes the pin receiving a recess of the second end of the gate, opposite the first end.

Another embodiment of the present disclosure is a lift vehicle. The lift vehicle includes a chassis, a lift assembly, and a platform. The lift assembly is coupled with the chassis. The platform is coupled with the lift assembly. The platform includes a base, a plurality of rails, and a deck. The plurality of rails at least partially surrounding the base. The deck is selectively coupled to the plurality of rails. The deck is moveable between a storage position and a use position. The deck includes a front side opposite a back side, a first lateral side, and a second lateral side opposite the first lateral side. The lateral sides extend between the front side and the back side. The deck includes a locking mechanism configured to secure the deck in at least one of the storage position or the use position. In the storage position, the deck is substantially perpendicular with the base and in the use position, the deck is substantially parallel with the base.

In some embodiments, the deck includes an extension control system configured to limit movement of the platform. The extension control system includes a lever, a pin, and a guide. The lever is coupled to the platform at a first end extending away from the base. The pin is coupled to a second end of the lever opposite the first end. The guide is coupled to a top end of the platform and comprising a first recess and a second recess. At least one of the first recess and the second recess are configured to receive the pin and provide a stop. In some embodiments, the extension control system includes a rivet coupled to the guide between the first recess and the second recess preventing the lever from moving between the first recess and the second recess.

In some embodiments, the deck includes a pair of flanges coupled at each of the lateral sides proximate the back side of the deck and a pair of channels coupled to the base at the lateral sides of the deck, the channels configured to selectively receive the flanges. Moving the deck from the storage position to the use position includes translating the flanges within the channels in a vertical direction and pivoting the deck around an axis defined by a pair of spring pins.

In some embodiments, the deck includes a pair of flanges coupled at each of the lateral sides proximate the back side of the deck and a pair of channels coupled to the base at the lateral sides of the deck, the channels configured to selectively receive the flanges. Moving the deck from the storage position to the use position includes translating the flanges within the channels in a vertical direction and pivoting the deck around an axis defined by a pair of spring pins.

In some embodiments, the locking mechanism includes a pair of spring pins, a cam, and a release rod. The pair of spring pins are at each of the lateral sides proximate the front side of the deck and moveable between an extended position and a retracted position. The cam is rotatably coupled to a bottom surface of the deck and coupled to each of the spring pins to move the spring pins between the extended and retracted positions. The release rod is coupled at one end to the cam and terminating in a release rod handle at an end of the release rod. In the retracted position, the deck is vertically translatable within the channels, and in the extended position, the spring pins are biased such that vertical translation of the deck is prevented.

In some embodiments, the platform includes an extendable rail assembly. The extendable rail assembly includes a plurality of guides coupled to the plurality of rails, a plurality of upright members extending within the plurality of guides away from the base, and a top rail extending between the plurality of upright members, wherein each of the plurality of upright members comprises at least one first aperture proximate an end of the plurality of upright members and at least one second aperture between the at least one first aperture and the top rail. The plurality of upright members and the top rail form a moveable rail assembly. In some embodiments, the moveable rail assembly is moveable between a retracted position and one or more extended positions, and the extendable rail assembly includes a rail lock mechanism configured to secure the moveable rail assembly in the retracted position and the one or more extended positions.

Another embodiment relates to a deck assembly for a platform. The deck assembly includes a deck selectively coupled to the platform and moveable between a storage position and a use position. The deck includes a front side opposite a back side, a first lateral side, and a second lateral side opposite the first lateral side. The lateral sides extend between the front side and the back side. The deck includes a locking mechanism configured to secure the deck in at least one of the storage position or the use position. The deck includes a pair of flanges coupled at each of the lateral sides proximate the back side of the deck. The deck includes a pair of channels at the lateral sides of the deck, the channels configured to selectively receive the flanges. The deck includes a pair of spring pins at each of the lateral sides proximate the front side of the deck and moveable between an extended position and a retracted position, wherein in the retracted position, the deck is vertically translatable within the channels. The deck includes a cam rotatably coupled to a bottom surface of the deck and coupled to each of the spring pins to move the spring pins between the extended and retracted positions. Moving the deck from the storage position to the use position includes translating the flanges within the channels in a vertical direction and pivoting the deck around an axis defined by the pair of spring pins.

### BRIEF DESCRIPTION OF THE FIGURES

FIG. 1 is a perspective view of a boom lift, according to some embodiments.

FIG. 2 is a perspective view of a scissors lift, according to some embodiments.

FIG. 3 is a perspective view of a platform assembly of the boom lift of FIG. 1 or the scissors lift of FIG. 2, according to some embodiments.

FIG. 4 is a side view of a platform assembly of the boom lift of FIG. 1 or the scissors lift of FIG. 2 including an extendable deck, according to some embodiments.

FIG. 5 is a perspective view of an extendable platform for the platform assembly of the boom lift of FIG. 1, with a stowable deck in a storage position and a moveable rail assembly in a compact position, according to some embodiments.

FIG. 6 is a perspective view of the extendable platform of FIG. 6, with the stowable deck in a storage position and the moveable rail assembly in a normal position, according to some embodiments.

FIG. 7 is a perspective view of the extendable platform of FIG. 6, with the stowable deck in a use position and the moveable rail assembly in an extended position, according to some embodiments.

FIG. 8 is a perspective view of the extendable platform of FIG. 6 in the platform assembly of the boom lift of FIG. 1, according to some embodiments.

FIG. 9 is a perspective view of the extendable platform of FIG. 6 in the platform assembly of the boom lift of FIG. 1 in an extended position, according to some embodiments.

FIG. 10 is a perspective view of the extendable platform of FIG. 6 in the platform assembly of the boom lift of FIG. 1 with the platform assembly rails and the moveable rail assembly in a compact position, according to some embodiments.

FIG. 11 is a front view of the stowable deck of FIG. 5, according to some embodiments.

FIG. 12 is a front perspective view of the stowable deck of FIG. 11, according to some embodiments.

FIG. 13 is a front view of the stowable deck of FIG. 5, according to some embodiments.

FIG. 14-16 are front perspective views of the stowable deck of FIG. 5 moving from a storage position to a use position, according to some embodiments.

FIG. 17 is a perspective view of the moveable rail assembly of FIG. 5 in a normal position, according to some embodiments.

FIG. 18 is a perspective view of the moveable rail assembly of FIG. 5 in an extended position, according to some embodiments.

FIG. 19 is a perspective view of the moveable rail assembly of FIG. 5 in a normal position, according to some embodiments.

FIG. 20 is a perspective view of a gate of the moveable rail assembly of FIG. 5, according to some embodiments.

FIG. 21 is another perspective view of a gate of the moveable rail assembly of FIG. 5, according to some embodiments.

FIG. 22 is a side view of an extension control system of the extendable platform of FIG. 5, according to some embodiments.

FIG. 23 is a perspective view of the extension control system of FIG. 22, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the figures, an extendable platform with a stowable deck and moveable rail assembly is shown coupled to a platform of a lift device. The stowable deck and moveable rail assembly allow a user to step higher up from what would otherwise be possible, while still surrounding a user with a rail system for safety. During operation there may be instances where just a simple step is required rather than adjusting the entire height of the lift device, and a user can simply raise the stowable deck and moveable rail assembly manually to allow them to reach higher without actuating the lifting assembly of the lift device. The stowable deck is positioned within channels of rails on either side of the extendable platform and is held in a storage or stow position by a plurality of spring pins. The spring pins are actuated by a release handle coupled via rods and a cam to the spring pins. The release handle is positioned proximate a handle of the stowable deck to allow a user to simultaneously grab the stowable deck (e.g., via the handle) and pull the release handle to release the spring pins. The user then pulls the stowable deck up through the channels until the spring pins automatically extend into recesses at the tops of the channels. The spring pins can then act as pivot pins allowing the stowable deck to fold down and rest on supports extending inwards from the rail assembly. To return the stowable deck to the storage or stowed position, the stowable deck is simply lifted and the release handle is pulled, releasing the spring pins so that the stowable deck can fall back down the channels until the spring pins engage the apertures at the bottom of the channels. Similarly, a user can manually actuate the moveable rail assembly. First the user rotates a handle to disengage a front pair of spring pins coupling the moveable rail assembly to the rails of the extendable deck. The user can raise the moveable rail assembly until the front spring pins and a pair of rear spring pins automatically engage apertures at or proximate the ends of the upright members of the moveable rail assembly, securing the moveable rail assembly in the extended position. To drop the moveable rail assembly back to the normal position, the rear spring pins are first disengaged and locked in the retracted state, before the handle is twisted again to release the front spring pins.

The moveable rail assembly can then fall back to the normal position. The moveable rail assembly can also be lowered from the normal position to the compact position by rotating the handle and in the normal position and letting the movable rail assembly fail, rather than lifting it to raise it to the extended position. Beneficially, the extendable platform can replace the extendable platform on pre-existing platforms to add the stowable deck and/or moveable rail assembly to pre-existing machines. It also allows a user to maintain access to the controls or I/O device of the platform even in the use position.

### Boom Lift

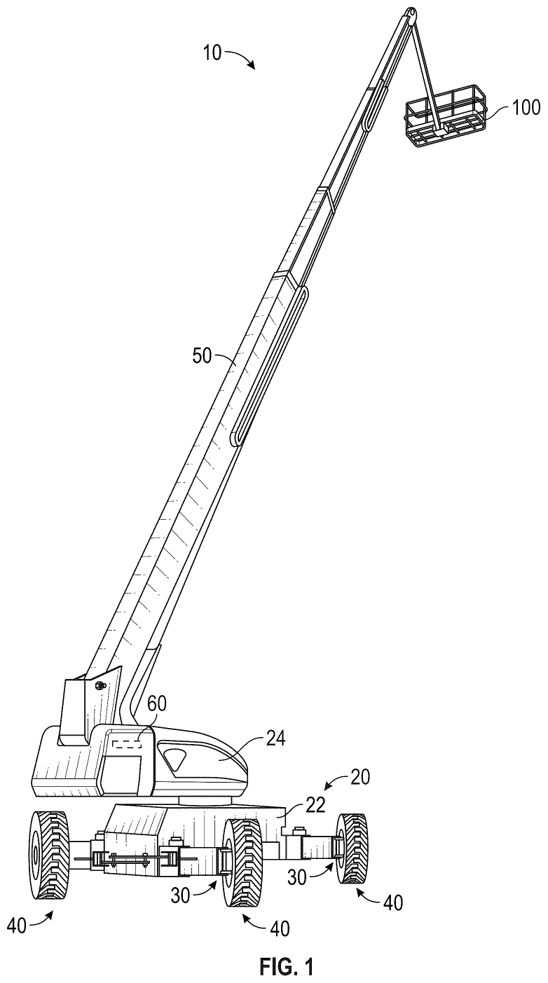

According to the exemplary embodiment shown in FIG. 1, a lift device (e.g., a boom, a telehandler, etc.), shown as lift device 10, includes a chassis, shown as chassis 20. According to an exemplary embodiment, the chassis 20 includes a frame, shown as frame 22. As shown in FIG. 1, the lift device includes a series of axles, shown as axles 30, coupled to the frame 22. In one embodiment, the lift device 10 includes a plurality of independent axles 30 (e.g., four, etc.) coupled to the frame 22. In another embodiment, the lift device 10 includes a first solid axle 30 coupled to a front end of the frame 22 and a second solid axle 30 coupled to a rear end of the frame 22. A wheel assembly (e.g., a wheel and tire assembly), shown as wheel assembly 40, is coupled to an end of each axle 30. The lift device 10 may include one or more actuators (e.g., hydraulic cylinders) to rotate the axles 30 relative to the frame 22 and/or to rotate the wheel assemblies 40 relative to the axles 30 (e.g., about respective vertical axes). This may facilitate varying the wheelbase of the lift device. The wheel assemblies 40 may include one or more actuators to drive the wheels and propel the lift device 10.

As shown in FIG. 1, the lift device 10 includes a lift assembly, shown as lift boom 50. In some embodiments, the lift boom 50 is rotatably coupled to the chassis 20. As shown in FIG. 1, the lift boom 50 is directly, pivotally coupled to a turntable 24 (e.g., such that the lift boom 50 rotates relative to the turntable 24 about a horizontal axis). The turntable 24 is rotatably coupled to the frame 22 (e.g., such that the lift boom 50 and the turntable 24 rotate relative to the frame 22 about a vertical axis). Rotation of the turntable 24 may be facilitated by a bearing disposed between the turntable 24 and the frame 22. As shown in FIG. 1, an operational device (e.g., an aerial work platform, a first platform), shown as platform 100, is coupled to an end of the lift boom 50 opposite the frame 22.

Referring still to FIG. 1, the lift boom 50 includes a plurality of telescoping boom sections. An actuator may extend the plurality of telescoping boom sections to increase the extension length of the lift boom 50 (e.g., during operation of the lift device 10 by an operator aboard the platform 100, etc.). According to the exemplary embodiment shown in FIG. 1, the lift boom 50 is pivotally coupled to the turntable 24 such that the platform 100 may be elevated relative to a ground surface. In one embodiment, an actuator pivots the lift boom 50 upward, thereby increasing a working height of the platform 100.

As shown in FIG. 1, the lift device 10 includes a controller 60. The controller 60 is configured to facilitate various operations of the lift device 10. By way of example, the controller 60 may be configured to provide command signals relating to the rotation of the turntable 24 and the lift boom 50 relative to the frame 22, the extension of the lift boom 50, and the rotation of at least one of the wheel assemblies 40 (e.g., to drive the lift device 10, etc.). The controller 60 may also be configured to engage at least one actuator to facilitate movement of at least one of the wheel assemblies 40, the turntable 24, the lift boom 50, and the platform 100. By way of another example, the controller 60 may be communicably coupled with an operator input/output (I/O) device (e.g., a user interface) such that an operator of the lift device 10 may provide a variety of commands to the controller 60.

In other embodiments, the platform 100 is used with a different lift device or vehicle. By way of example, the platform 100 may be used with a boom lift, a scissor lift, a vertical lift, a telehandler outfitted with an operator platform, a crane, or another lift device. In yet other embodiments, the platform 100 is a fixed, stationary, or immobile platform, such as a catwalk, a scaffold, or a floor of a building.

### Scissors Lift

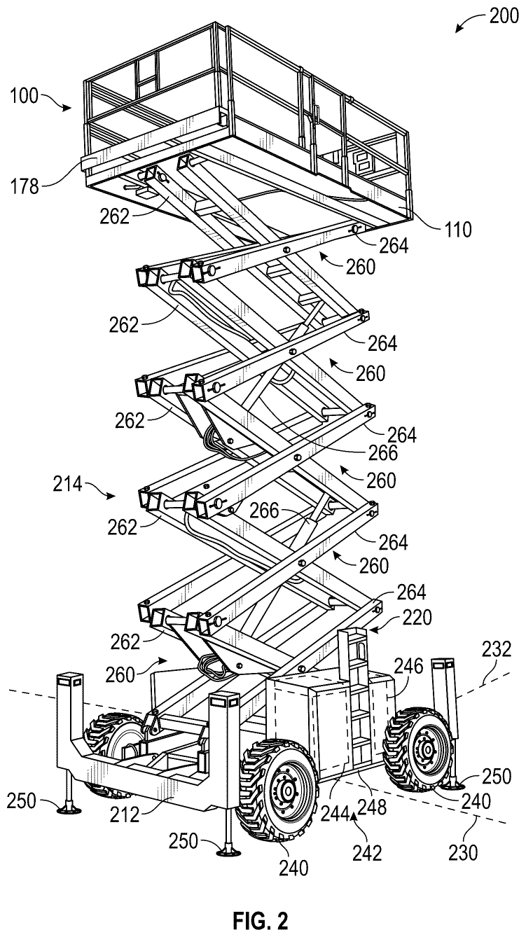

According to the exemplary embodiment shown in FIG. 2, a lift device (e.g., a scissor lift, an aerial work platform, a boom lift, a telehandler, etc.), shown as scissors lift 200, includes a chassis, shown as frame assembly 212. A lift device (e.g., a scissor assembly, a boom assembly, etc.), shown as lift assembly 214, couples the frame assembly 212 to a platform, shown as platform 100. The frame assembly 212 supports the lift assembly 214 and the platform 100, both of which are disposed directly above the frame assembly 212. In use, the lift assembly 214 extends and retracts to raise and lower the platform 100 relative to the frame assembly 212 between a lowered position and a raised position. The scissors lift 200 includes an access assembly, shown as an access assembly 220, that is coupled to the frame assembly 212 and configured to facilitate access to the platform 100 from the ground by an operator when the platform 100 is in the lowered position.

Referring again to FIG. 2, the frame assembly 212 defines a horizontal plane having a lateral axis 230 and a longitudinal axis 232. In some embodiments, the frame assembly 212 is rectangular, defining lateral sides extending parallel to the lateral axis 230 and longitudinal sides extending parallel to the longitudinal axis 232. In some embodiments, the frame assembly 212 is longer in a longitudinal direction than in a lateral direction. In some embodiments, the scissors lift 200 is configured to be stationary or semi-permanent (e.g., a system that is installed in one location at a work site for the duration of a construction project). In such embodiments, the frame assembly 212 may be configured to rest directly on the ground and/or the scissors lift 200 may not provide powered movement across the ground. In other embodiments, the scissors lift 200 is configured to be moved frequently (e.g., to work on different tasks, to continue the same task in multiple locations, to travel across a job site, etc.). Such embodiments may include systems that provide powered movement across the ground.

Referring to FIG. 2, the scissors lift 200 is supported by a plurality of tractive assemblies 240, each including a tractive element (e.g., a tire, a track, etc.), that are rotatably coupled to the frame assembly 212. The tractive assemblies 240 may be powered or unpowered. As shown in FIG. 2, the tractive assemblies 240 are configured to provide powered motion in the direction of the longitudinal axis 232. One or more of the tractive assemblies 240 may be turnable to steer the scissors lift 200. In some embodiments, the scissors lift 200 includes a powertrain system 242. In some embodiments, the powertrain system 242 includes a primary driver 244 (e.g., an engine). A transmission may receive the mechanical energy and provide an output to one or more of the tractive assemblies 240. In some embodiments, the powertrain system 242 includes a pump 246 configured to receive mechanical energy from the primary driver 244 and output a pressurized flow of hydraulic fluid. The pump 246 may supply mechanical energy (e.g., through a pressurized flow of hydraulic fluid) to individual motive drivers (e.g., hydraulic motors) configured to facilitate independently driving each of the tractive assemblies 240. In other embodiments, the powertrain system 242 includes an energy storage device (e.g., a battery, capacitors, ultra-capacitors, etc.) and/or is electrically coupled to an outside source of electrical energy (e.g., a standard power outlet). In some such embodiments, one or more of the tractive assemblies 240 include an individual motive driver (e.g., a motor that is electrically coupled to the energy storage device, etc.) configured to facilitate independently driving each of the tractive assemblies 240. The outside source of electrical energy may charge the energy storage device or power the motive drivers directly. The powertrain system 242 may additionally or alternatively provide mechanical energy (e.g., using the pump 246, by supplying electrical energy, etc.) to one or more actuators of the scissors lift 200 (e.g., the leveling actuators 250, the lift actuators 266, etc.). One or more components of the powertrain system 242 may be housed in an enclosure, shown as housing 248. The housing 248 is coupled to the frame assembly 212 and extends from a side of the scissors lift 200 (e.g., a left or right side). The housing 248 may include one or more doors to facilitate access to components of the powertrain system 242.

In some embodiments, the frame assembly 212 is coupled to one or more actuators, shown in FIG. 2 as leveling actuators 250. The scissors lift 200 includes four leveling actuators 250, one in each corner of the frame assembly 212. The leveling actuators 250 extend and retract vertically between a stored position and a deployed position. In the stored position, the leveling actuators 250 are raised and do not contact the ground. In the deployed position, the leveling actuators 250 contact the ground, lifting the frame assembly 212. The length of each of the leveling actuators 250 in their respective deployed positions may be varied to adjust the pitch (i.e., rotational position about the lateral axis 230) and the roll (i.e., rotational position about the longitudinal axis 232) of the frame assembly 212. Accordingly, the lengths of the leveling actuators 250 in their respective deployed positions may be adjusted such that the frame assembly 212 is leveled with respect to the direction of gravity, even on uneven or sloped terrains. The leveling actuators 250 may additionally lift the tractive elements of the tractive assemblies 240 off the ground, preventing inadvertent driving of the scissors lift 200.

Referring to FIG. 2, the lift assembly 214 includes a number of subassemblies, shown as scissor layers 260, each including a first member, shown as inner member 262, and a second member, shown as outer member 264. In each scissor layer 260, the outer member 264 receives the inner member 262. The inner member 262 is pivotally coupled to the outer member 264 near the centers of both the inner member 262 and the outer member 264. Accordingly, inner member 262 pivots relative to the outer member 264 about a lateral axis. The scissor layers 260 are stacked atop one another to form the lift assembly 214. Each inner member 262 and each outer member 264 has a top end and a bottom end. The bottom end of each inner member 262 is pivotally coupled to the top end of the outer member 264 immediately below it, and the bottom end of each outer member 264 is pivotally coupled to the top end of the inner member 262 immediately below it. Accordingly, each of the scissor layers 260 are coupled to one another such that movement of one scissor layer 260 causes a similar movement in all of the other scissor layers 260. The bottom ends of the inner member 262 and the outer member 264 belonging to the lowermost of the scissor layers 260 are coupled to the frame assembly 212. The top ends of the inner member 262 and the outer member 264 belonging to the uppermost of the scissor layers 260 are coupled to the platform 100. The inner members 262 and/or the outer members 264 are slidably coupled to the frame assembly 212 and the platform 100 to facilitate the movement of the lift assembly 214. Scissor layers 260 may be added to or removed from the lift assembly 214 to increase or decrease, respectively, the maximum height that the platform 100 is configured to reach.

One or more actuators (e.g., hydraulic cylinders, pneumatic cylinders, motor-driven leadscrews, etc.), shown as lift actuators 266, are configured to extend and retract the lift assembly 214. As shown in FIG. 2, the lift assembly 214 includes a pair of lift actuators 266. Lift actuators 266 are pivotally coupled to an inner member 262 at one end and pivotally coupled to another inner member 262 at the opposite end. These inner members 262 belong to a first scissor layer 260 and a second scissor layer 260 that are separated by a third scissor layer 260. In other embodiments, the lift assembly 214 includes more or fewer lift actuators 266 and/or the lift actuators 266 are otherwise arranged. The lift actuators 266 are configured to actuate the lift assembly 214 to selectively reposition the platform 100 between the lowered position, where the platform 100 is proximate the frame assembly 212, and the raised position, where the platform 100 is at an elevated height. In some embodiments, extension of the lift actuators 266 moves the platform 100 vertically upward (extending the lift assembly 214), and retraction of the linear actuators moves the platform 100 vertically downward (retracting the lift assembly 214). In other embodiments, extension of the lift actuators 266 retracts the lift assembly 214, and retraction of the lift actuators 266 extends the lift assembly 214. In some embodiments, the outer members 264 are approximately parallel and/or contacting one another when with the lift assembly 214 in a stored position. The scissors lift 200 may include various components to drive the lift actuators 266 (e.g., pumps, valves, compressors, motors, batteries, voltage regulators, etc.).

Referring again to FIG. 2, the platform 100 includes a support surface, shown as base 110, defining a top surface configured to support operators and/or equipment and a bottom surface opposite the top surface. The bottom surface and/or the top surface extend in a substantially horizontal plane. A thickness of the base 110 is defined between the top surface and the bottom surface. The bottom surface is coupled to a top end of the lift assembly 214. In some embodiments, the base 110 is rectangular. In some embodiments, the base 110 has a footprint that is substantially similar to that of the frame assembly 212.

Referring again to FIG. 2, the platform 100 further includes one or more platforms, shown as extendable decks 178, that are received by the base 110 and that each define a top surface. The extendable decks 178 are selectively slidable relative to the base 110 between an extended position and a retracted position. In the retracted position, shown in FIG. 2, the extendable decks 178 are completely or almost completely received by the base 110. In the extended position, the extendable decks 178 project outward (e.g., longitudinally, laterally, etc.) relative to the base 110 such that their top surfaces are exposed. With the extendable decks 178 projected, the top surfaces of the extendable decks 178 and the top surface of the base 110 are all configured to support operators and/or equipment, expanding the supported area. In some embodiments, the extendable decks 178 include guard rails partially or fully enclose the supported area. The extendable decks 178 facilitate accessing areas that are spaced outward from the frame assembly 212.

### Platform

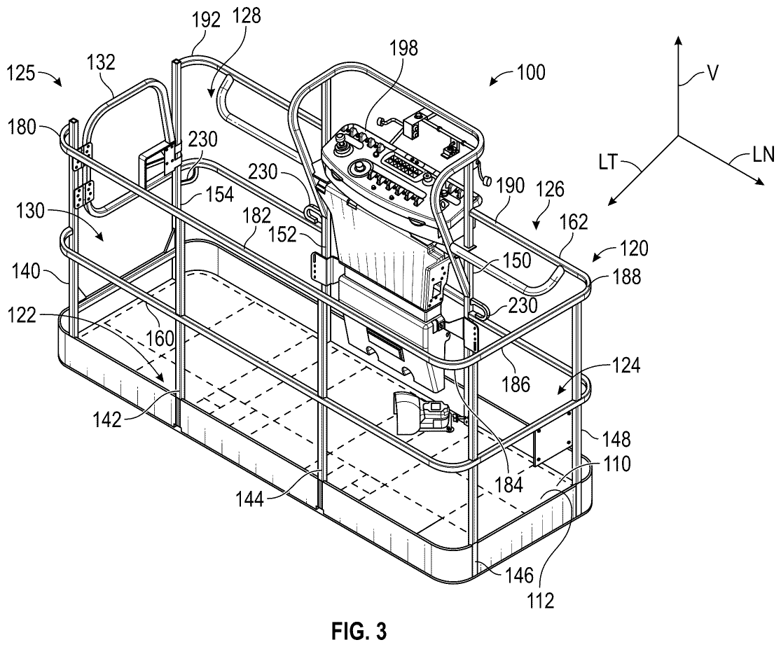

Referring to FIG. 3, the platform 100 is shown according to an exemplary embodiment. The platform 100 is configured to support an operator while elevated above the ground. The operator may perform one or more tasks while supported by the platform 100, or the operator may use the platform 100 to reach an elevated surface and subsequently exit the platform 100. A vertical axis V, a lateral axis LT, and a longitudinal axis LN are defined with respect to the platform.

The platform 100 includes a flat support surface, base, or platform, shown as base 110. A top surface of the base 110 (i.e., a support surface 112) is configured to support one or more operators. The support surface 112 may be a continuous, substantially flat surface, or the support surface 112 may include multiple sections that are separated from one another by one or more obstructions (e.g., a gap, a protrusion, etc.). By way of example, the base 110 may include one or more sheets of expanded metal.

The platform 100 further includes a hand railing, rail, handrail, handrail, guiderail, or boundary assembly, shown as handrail 120. The handrail 120 is configured to provide support for an operator and to prevent the operator from falling off of the platform 100. The handrail 120 is fixedly coupled to the base 110 and extends upward, above the support surface 112. The handrail 120 extends along a perimeter of the base 110. Specifically, as shown in FIG. 2, the handrail 120 includes a front portion 122 extending along a front side of the base 110, a right portion 124 extending along a right side of the base 110, and a rear portion 126 extending along the rear side of the base 110. As shown, the front portion 122, the right portion 124, and the rear portion 126 are continuous with one another. In other embodiments, the front portion 122, the right portion 124, and/or the rear portion 126 are (a) separated by one or more gaps, (b) made up of multiple sections, and/or (c) omitted. A volume, shown as working area 128, is defined between the base 110, the front portion 122, the right portion 124, and the rear portion 126. The working area 128 defines an area in which an operator can stand upon the base 110 while being contained within the handrail 120.

An aperture, gap, or opening, shown as doorway 130, is defined at the left side of the base 110 between the front portion 122 and the rear portion 126. A door or gate, shown as gate 132, selectively extends across the doorway 130 to prevent passage of the operator through the doorway 130. Specifically, the gate 132 is pivotally coupled to the front portion 122 (e.g., by a hinge) and selectively coupled to the rear portion 126 (e.g., by a latch).

The handrail 120 includes a series of upright members (e.g., members that are substantially vertical when the base 110 is level) and a series of horizontal members (e.g., members that are substantially horizontal when the base 110 is level). The upright members are approximately evenly spaced along the perimeter of the base 110 and fixedly coupled to the base 110. Specifically, proceeding counterclockwise as viewed from above, the handrail 120 includes the following upright members: upright member 140, upright member 142, upright member 144, upright member 146, upright member 148, upright member 150, upright member 152, and upright member 154. The handrail 120 includes a first horizontal member, shown as middle rail 160, and a second horizontal member or handrail, shown as top rail 162. The middle rail 160 is positioned between the top rail 162 and the base 110. The top rail 162 defines a top surface of the handrail 120. Each horizontal member or vertical member may include a single member or multiple members that are substantially aligned with one another. By way of example, the upright member 154 includes a single, continuous member, whereas the upright member 144 is bisected by the middle rail 160.

As shown, the top rail 162 includes a series of curved and straight sections that are arranged in a generally C-shape extending from the upright member 140 to the upright member 154. A first curved section 180 is coupled to a top end portion of the first upright member 140. A first straight section 182 extends in a longitudinal direction from the first curved section 180 to a second curved section 184. The first straight section 182 is coupled to top end portions of the upright member 142 and the upright member 144. A second straight section 186 extends between the second curved section 184 and a third curved section 188. The second straight section 186 is coupled to top end portions of the upright member 146 and the upright member 148. A third straight section 190 extends between the third curved section 188 and a fourth curved section 192. The third straight section 190 is formed in two parts, each part being coupled to a middle section of the upright member 150 or the upright member 152. The fourth curved section 192 is coupled to the upright member 154. As shown, each curved section is curved approximately 90 degrees.

The platform 100 provides a surface upon which operators stand while operating the lift device 10 with an I/O device 198. Specifically, the I/O device 198 is coupled to the handrail 120 between the upright member 150 and the upright member 152. The I/O device 198 faces inward such that it can be used by an operator standing within the working area 128. In one embodiment, the I/O device 198 is communicably coupled to various components of the lift device 10 (e.g., the wheel assemblies 40, the turntable 24, the lift boom 50, the platform 100, the controller 60, etc.) such that information or signals (e.g., command signals, etc.) may be exchanged to and from the I/O device 198. By way of example, the I/O device 198 may include at least one of an interactive display, a touchscreen device, one or more buttons, joysticks, switches, and/or voice command receivers. An operator may use a joystick associated with the I/O device 198 to trigger the engagement of an actuator positioned to turn one of the wheel assemblies 40, thereby turning the lift device 10 towards a desired location. By way of another example, an operator may engage a lever associated with the I/O device 198 to trigger the extension or retraction of the plurality of sections of the lift boom 50.

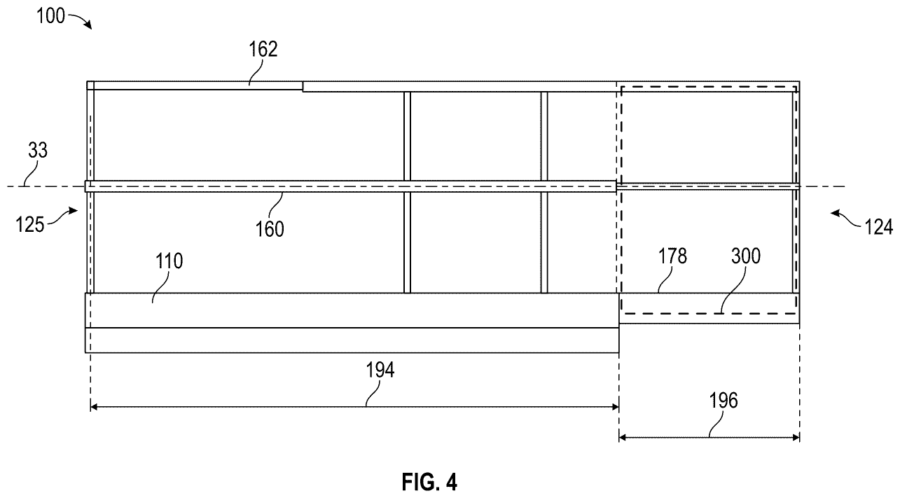

Referring to FIG. 4, the extendable deck 178 can be extended in a longitudinal direction along longitudinal axis 33. The extendable deck 178 can telescope from the base 110. The platform 100 can include telescoping upper rails 162 and middle rails 160 such that the upper rails 162 and the middle rails 160 of the extendable deck 178 telescope as the extendable deck 178 is extended or retracted. The extendable deck 178 can also protrude from a lateral side of the platform 100. The extendable deck 178 can be disposed on the right portion 124 or a left portion 125 of the platform 100. The extendable deck 178 can define an end of the platform 100. When the extendable deck 178 is fully retracted, the platform 100 has an overall length 194. The extendable deck 178 can be transitioned or moved into the extended position an additional length 196.

The extendable deck 178 can include a stowable deck 350 that is a part of the extendable deck 178. In some embodiments, the stowable deck 350 is coupled to a portion of the extendable deck 178 (e.g., coupled to the middle rails 160 and the upper rails 162). In some embodiments, the stowable deck 350 is coupled to rails of the platform 100 of the scissors lift 200 or the lift device 10. In some embodiments, the stowable deck 350 forms an end of the platform 100 (e.g., a longitudinal end shown as right portion 124 or left portion 125).

### Stowable Deck

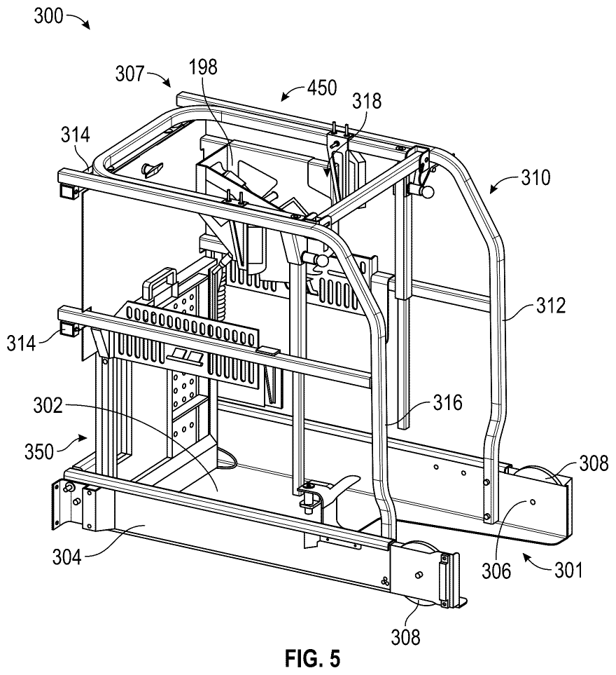

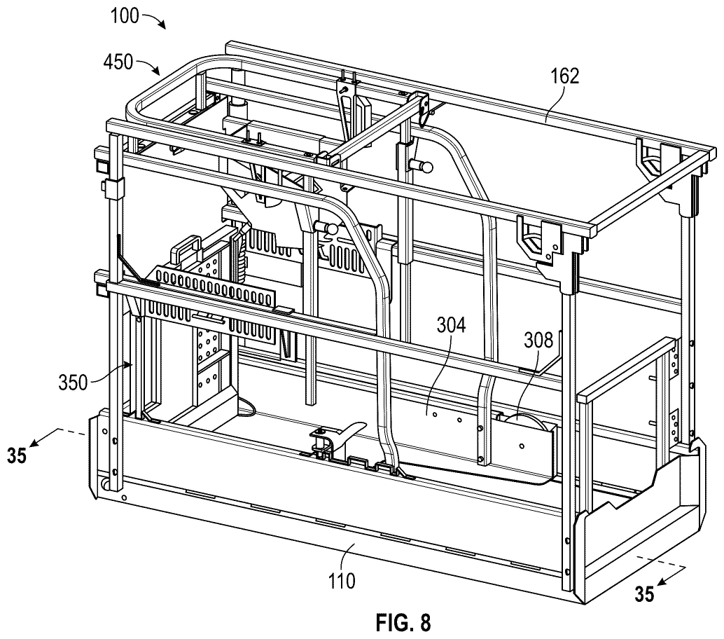

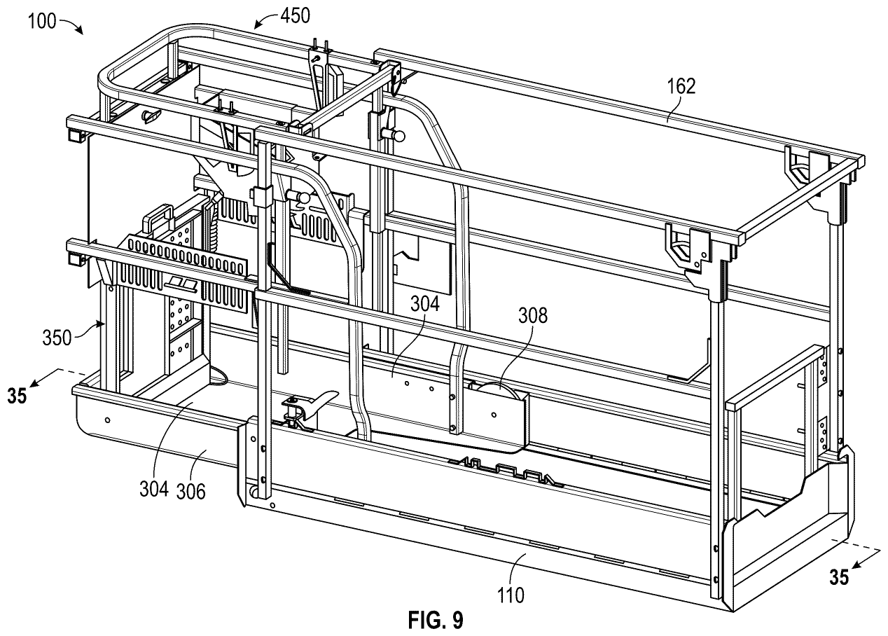

Referring to FIG. 5-7, among others, an extendable platform 300 (e.g., extendable platform assembly, a platform, a deck, etc.) is shown including a stowable deck 350. Additionally or alternatively, the extendable platform 300 includes a moveable rail assembly 450, as shown in FIG. 5-7, among others. The extendable platform 300 can be the same or similar to the extendable deck 178 and may be a part of platform 100. This arrangement is discussed in further detail below with reference to FIG. 8-10. The extendable platform 300 includes a platform or frame shown as base 302 and a hand railing, rail, handrail, handrail, guiderail, or boundary assembly, shown as handrail 310. The handrail 310 is configured to provide support for an operator and to prevent the operator from falling off of the extendable platform 300. The handrail 310 is fixedly coupled to the base 302 and extends upward, above the support surface 303. The handrail 310 extends along an outer perimeter of the base 302 but includes aperture, gap, or opening, shown as open end 301, defined at one end of the base 302. The handrail 310 includes a closed end, opposite the open end 301, shown as closed end 307.

Specifically, as shown in FIG. 2, the handrail 310 includes a right portion 312 extending along a right side of the base 302, a rear portion 314 extending along a rear side 305 of the base 302 opposite the open end 301, and a left portion 316 extending along the left side of the base 302. As shown, the right portion 312, the rear portion 314, and the left portion 316 are continuous with one another. In other embodiments, the right portion 312, the rear portion 314, and/or the left portion 316 are (a) separated by one or more gaps, (b) made up of multiple sections, and/or (c) omitted. When the extendable platform 300 extends from the base 110, a volume, shown as working area 318, is defined between the base 302, the right portion 312, the rear portion 314, and the left portion 316 (e.g., the handrail 310) and the handrail 120. The working area 318 defines an area in which an operator can stand upon the base 302 while being surrounded by the handrail 310 and the handrail 120.

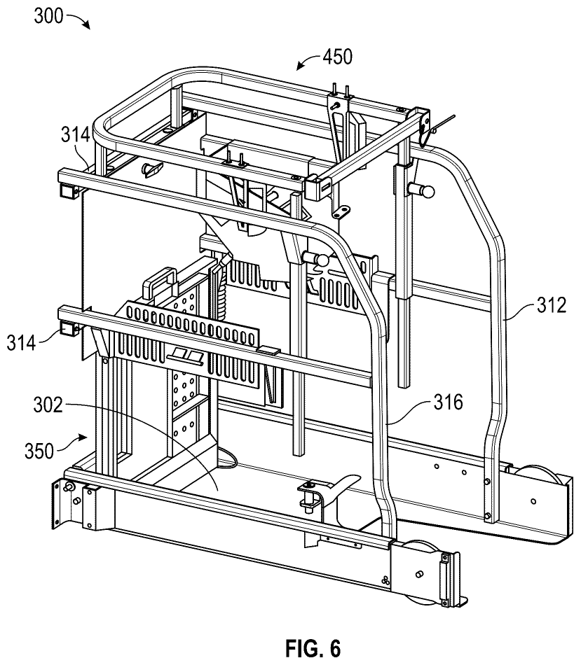

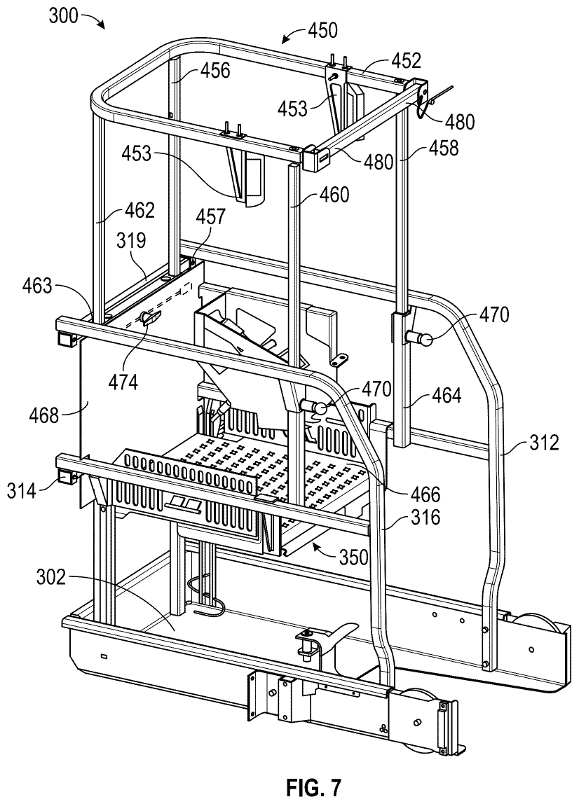

Referring to FIG. 5-7, the stowable deck 350 is moveable between a storage position as shown in FIG. 5 and a use position as shown in FIG. 7. FIG. 6 illustrates the movement of the stowable deck 350 between the storage position and the use position. Referring still to FIG. 5-7, the moveable rail assembly 450 is moveable between a compact position (e.g., a retracted position) as shown in FIG. 5, a storage position as shown in FIG. 6, and an extended position as shown in FIG. 7. In the compact position, a top of the moveable rail assembly 450 is substantially parallel to or positioned below a top of the handrail 310. In the storage position, the moveable rail assembly 450 extends a first distance above the top of the handrail 310. In the extended position, the moveable rail assembly 450 extends a second distance above the top of the handrail 310, where the second distance is greater than the first distance. In each position, the user is still able to access the I/O device 198 in the extendable platform 300.

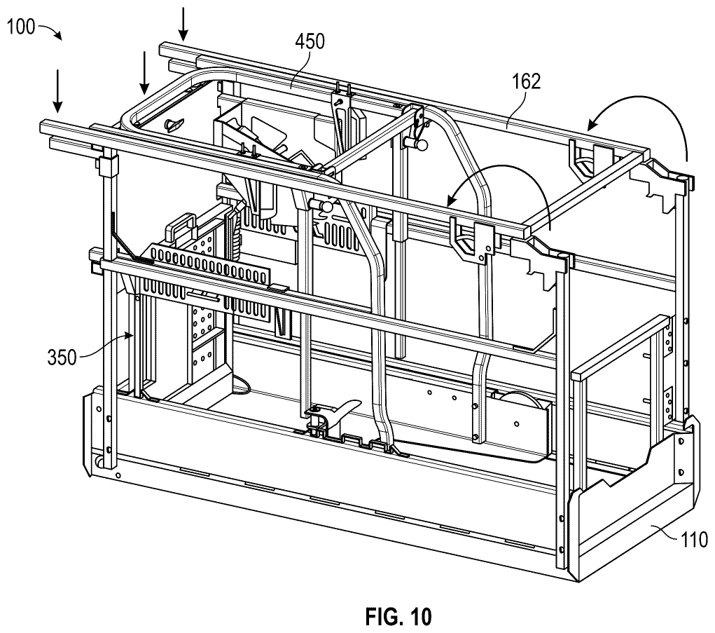

Referring now to FIG. 8-10, the extendable platform 300 is shown as part of the platform 100. As shown in FIGS. 5 and 6, the extendable platform 300 can translate along the longitudinal axis 35 relative to the base 110. The extendable platform 300 can include walls 304 and 306 which slide within the width of the platform 100 on wheels 308 which engage the base 110 to allow the extendable platform 300 to move relative the base 110. As shown in FIG. 10, the top rail 162 is hingedly coupled to the one or more upright members to move between a compact position and a normal position. The compact position of the moveable rail assembly 450 corresponds to the compact position of the top rail 162 to allow the entire height of the platform 100 to be reduced. The storage position of the moveable rail assembly 450 corresponds to use position of the top rail 162. In some embodiments, the top rail 162 and the moveable rail assembly 450 move separately between the respective positions, while in other movements the top rail 162 and the moveable rail assembly 450 are linked such that as the moveable rail assembly 450 moves between the compact position and the storage position, the top rail 162 moves between the compact position and the use position.

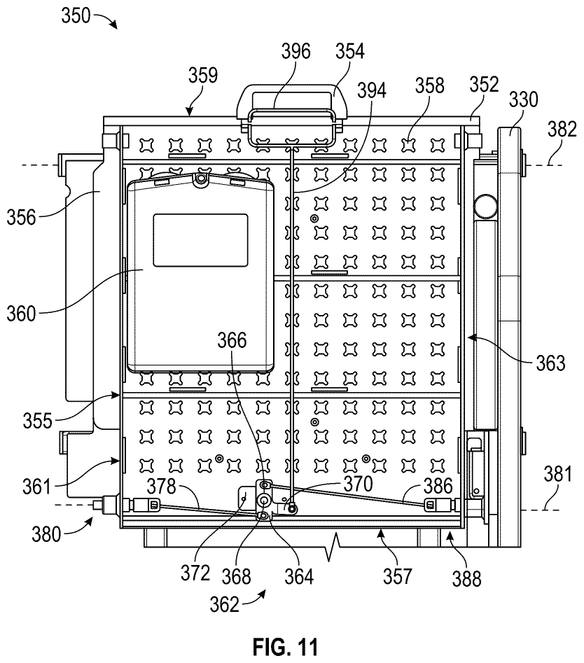

Referring now to FIG. 11, the stowable deck 350 is shown in greater detail. The stowable deck 350 includes a platform, step, base, support, shown as deck 352. Deck 352 includes a top surface 353 and a bottom surface 355, the bottom surface 355 opposite the top surface 353. Deck 352 includes a front side 357 and a back side 359, the back side 359 opposite the front side 357. Deck 352 includes a handle 354 extending from the back side 359 of the deck 352. Deck 352 includes a first lateral side 361, and a second lateral side 363 opposite the first lateral side 361. The first lateral side 361 and the second lateral side 363 extend between the front side 357 and the back side 359 of the deck 352. Deck 352 also includes flanges 356 extending between the front side 357 and the back side 359 of the deck 352. The flanges 356 extend into the voids defined by the channels 330. The channels 330 and 332 are coupled to the base 302 and define a void or track that receives the flanges 356. As the flanges 356 extend into the channels 330, 332, the deck 352 is retained by the channels 330, 332 in a substantially vertical position perpendicular to the base 302. The flanges 356 can translate or slide within the channels as the deck 352 moves up and down. The deck 352 is shown to include a plurality of apertures 358. The apertures 358 are cross-shaped and repeat across the deck 352. While shown as cross-shaped, the apertures may be other shapes such as circles, squares, rectangles, triangles, etc. Coupled to the bottom surface 355 of the deck 352 is a housing 360. The housing 360 may be a storage box to hold tools or components which may be accessible to an operator on the platform 100. The housing 360 is fixedly coupled to the deck 352 such that the housing moves with the deck 352.

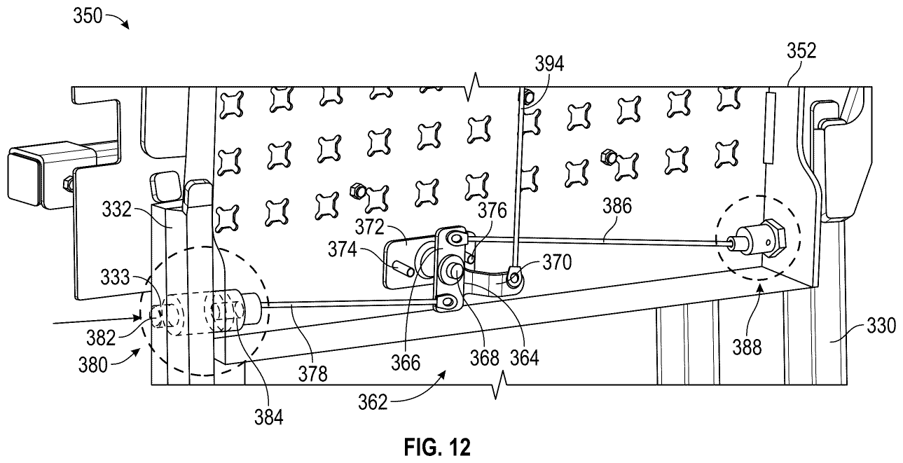

Referring now to FIGS. 11 and 12, at the front side 357 of the deck 352 is a locking assembly shown as locking mechanism 362. Locking mechanism 362 includes a cam 364. The cam 364 includes a center portion 366 which rotates around a center 368 and a tab 370 extending away from the center portion 366. The tab 370 is laterally offset from the center portion 366 such that the center portion 366 and the tab 370 rotate in different planes around the center 368. The cam 364 is rotatably coupled to a bottom of the deck 352 (e.g., bottom surface 355) by a bracket 372. The bracket 372 includes a first post 374 and a second post 376 extending from the bracket 372 away from the bottom of the deck 352. The first post 374 and the second post 376 limit a rotation of the center portion 366 of the cam between a neutral position referred to herein as a locked position and a second position in which the center portion 366 is proximate to or engages one or more of the first post 374 and the second post 376 referred to herein as an unlocked position. The second post 376 does not interfere with the rotation of the tab 370 due to the tabs extending laterally away from the cam 364. This allows the tab 370 to pass over the second post 376 as the cam 364 rotates until the center portion 366 engages at least one of the first post 374 or the second post 376.

A connecting member or element shown as rod 378 is rotatably coupled at a first end of the rod 378 to a first end of the center portion 366. While shown as a rod 378, the connecting member may also be wire, cord, string, or another material which can transfer tension forces. The rod 378, for example, a second end of the rod 378 opposite the first end of the rod 378, is coupled at a second end to a spring pin 380. The spring pin 380 is movable between an extended position and a retracted position. The spring pin 380 includes a pin 382 and a spring 384. The spring 384 biases the pin 382 to the extended position. A second connection member or element shown as rod 386 is rotatable coupled at a first end of the rod 386 to a second end of the center portion 366. The second rod 386 is coupled at a second end to a spring pin 388. The spring pin 388 is movable between an extended position and a retracted position. The spring pin 388 includes a pin 390 and a spring 392. The spring 392 biases the pin 390 to the extended position. Referring specifically to FIG. 10, the pins 382, 390 extend through apertures 331, 333 in the channels 330, 332 to lock a position of the deck 352 along the channels 330, 332. Each of the channels 330, 332 may have a plurality of apertures to allow the deck to move and be secured at a number of positions along the channels 330, 332.

The rods 378, 386 couple the cam 364 to the spring pins 380, 388. Rotation of the cam 364 counterclockwise about the center 368 cause the rods 378, 386 to pull on the spring pins 380, 388. The pulling force of the rods 378, 386 on the pins 382, 390 causes the pins to move from the extended position to the retracted position, against the force of the springs 384, 392, pulling the pins from the apertures 331, 333. With the spring pins 380, 388 in the retracted position, the deck 352 is free to translate vertically within the channels 330, 332.

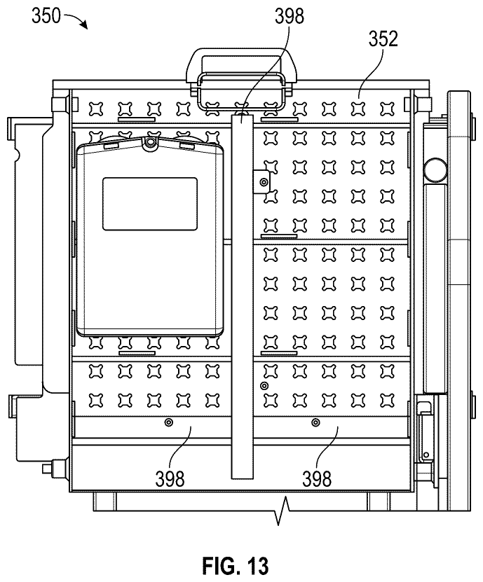

A connecting member or element shown as release rod 394 is rotatably coupled at one end to a free end of the tab 370. As the tab 370 extends away from the center portion 366 and the center 368, when the release rod 394 is pulled up, it causes the cam 364 to rotate counterclockwise around the center 368 and actuates the spring pins 380, 388. At a second end of the release rod 394 opposite the first end is a release handle 396. The release handle 396 is positioned proximate the handle 354 such that a user grasping handle 354 can also engage release handle 396 at the same time. The user pulling up and/or out on the release handle 396 causes the release rod 394 to pull on the tab 370, which causes the cam 364 to rotate and actuate the spring pins 380, 388 between the extended and retracted positions. When the release handle 396 is let go, the springs 384, 392 biasing the spring pins 380, 388 back out. So long as the spring pins 380, 388 are free to move, the pins 382, 390 will move back to the extended position. In some embodiments, an additional spring is coupled to the cam 364 to bias the came to the neutral position between the first post 374 and the second post 376. As shown in FIG. 13, the stowable deck 350 includes a plurality of covers 398 which enclose the locking mechanism 362.

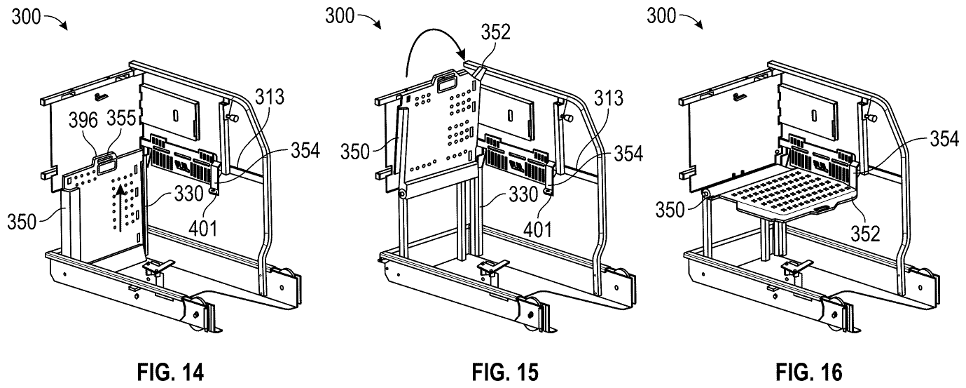

Referring now to FIG. 14-16, the movement of the stowable deck 352 from the storage position in FIG. 12 to the use position in FIG. 14 is illustrated. First, at step one a user grabs handle 354 and release handle 396, pulling the release handle 396 up and away from the cam 364, causing the cam 364 to rotate around the center 368 and actuate the spring pins 380, 388 from the extended position where the pins 382, 390 extend into apertures 331, 333 in the channels 330, 332 to the retracted position where the pins 382, 390 are withdrawn from the apertures 331, 333. At step two, the user lifts the deck 352 up and away from the base 302. The flanges 356 extending in the channels 330, 332 translate within the channels 330, 332 until they exit the channels 330, 332 at a channel exit 335, 337 of each channel 330, 332. At the top of one or more of the channels 330, 332 is a rod or element shown as stop 339. The stop 339 engages with the spring pins 380, 388 and blocks the voids of the channels 330, 332 such that the deck 352 cannot be entirely removed from the channels 330, 332. Proximate the stops are additional apertures 331, 333 in the channels 330, 332. The additional apertures 331, 333 (shown in FIG. 10) allow the pins 382, 390 of the spring pins 380, 388 to extend back to the normal extended position due to the bias of the springs 384, 392. The spring pins 380, 388 thereby secure the deck 352 to the channels 330, 332.

At step 3 as shown in FIG. 13, the springs pins 380, 388 have extended into the apertures 331, 333 and now act as a pivot pins for the deck 352 as the back of the deck 352 rotates down towards the base 302. The deck 352 rotates about the axis defined by the spring pins 380, 388 until the deck 352 engages with one or more supports, hooks, or brackets shown as supports 399. The supports 399 are coupled to a middle rail 313 of the extendable platform 300 and include a lip or flange 401 that extends onto into the working area 318. In the use position as shown in FIG. 14, the deck 352 rests on the flange 401 of the support 399 at a position substantially perpendicular to the base 302. In the use position, the deck 352 acts as a step or platform to allow a user to reach higher than would otherwise be possible with the base 302 alone.

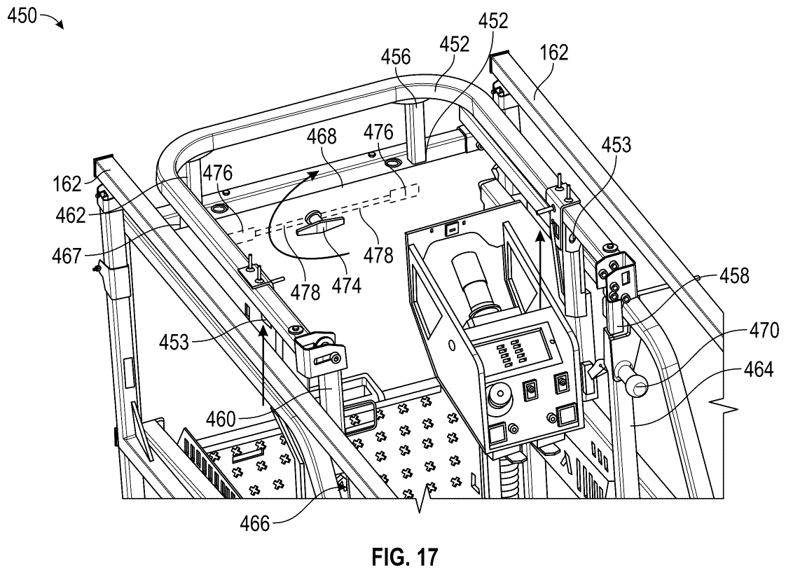

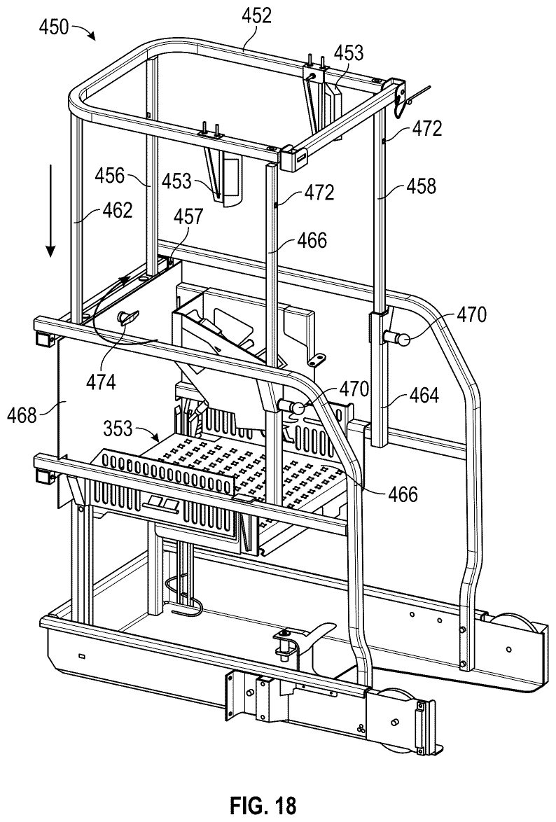

Referring now to FIG. 17-19, the moveable rail assembly 450 is shown in more detail moving between the retracted position shown in FIG. 17 and the extended position shown in FIG. 18. The moveable rail assembly includes a top rail 452 and a plurality of upright members 454 (e.g., members that are substantially vertical when the base 302 is level, longitudinal rails) shown as upright members 456, 458, 460 and 462. The top rail 425 extends between each of the upright plurality of upright members 454 and partially encloses the base 302 in a C-shape. In tandem with the top rail 162 of the handrail 120, the top rail 425 surrounds a user in the working area 318.

The upright members 458, 460 are positioned within guides 464, 466 coupled to the handrail 120. The guides 464, 466 substantially surround the upright members 458, 460 and allow the upright members 458, 460 to translate vertically within them. The upright members 456, 462 are positioned within a wall 468. The wall 468 includes apertures 457, 463 to receive the upright members 458, 460 respectively. The apertures 457, 463 act as guides and allow the upright members 458, 460 translate vertically within them similar to guides 464, 466. One or more of the guides 464, 466 includes at least one auxiliary spring pin, shown as spring pin 470. Spring pin 470 may be a locking spring pin. The locking spring pin 470 can move between an extended state and a retracted state. In one or more of the extended state or the retracted state, a knob on an end of the spring pin 470 can be turned which locks the spring pin in its present state. The upright members 458, 460 include one or more apertures to receive the spring pin 470 at different points along the upright members to secure the moveable rail assembly 450 in the normal position or the extended position. In the compact position, the spring pins 470 may not be used and the top rail 452 may rest directly on the guides 464, 466 and/or the wall 468.

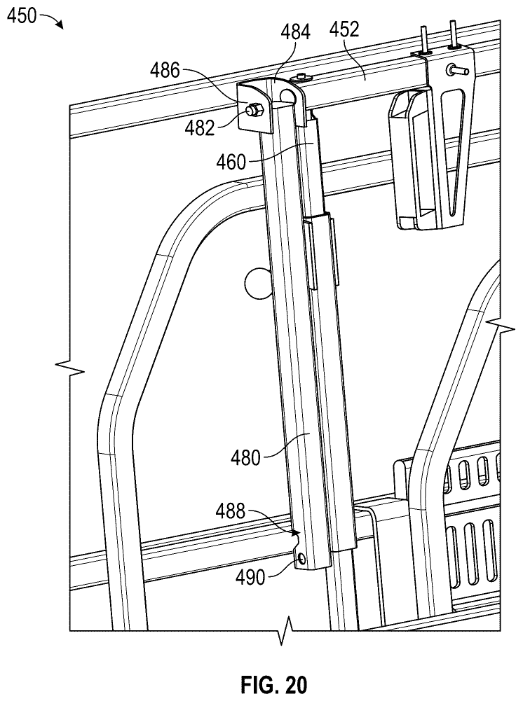

Referring now to FIG. 20, on the wall 468 is a handle 474. The handle 474 is coupled to spring pins 476 by rods 478. Rotation of the handle 474 causes the spring pins 476 to move between the extended position and the retracted position. The spring pins 476 and/or the handle 474 may be biased by one or more springs into the extended position, or a neutral position of the handle 474 respectively. The spring pins 476 in the extended position extend into apertures in the upright members 456, 462 and secure the upright members 456, 462 at a set position and height from the base 302.

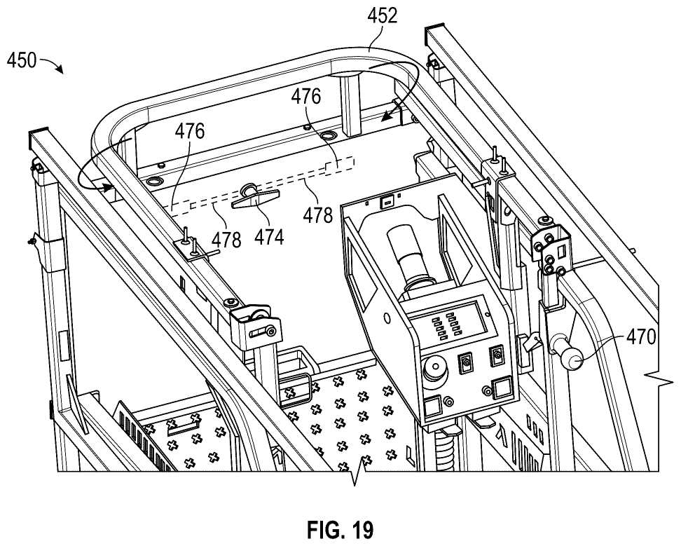

In operation to move the moveable rail assembly 450 from the normal position in FIG. 13 to the extended position in FIG. 17, the handle 474 is rotated to actuate the spring pins 476 (at a front of the moveable rail assembly 450) which withdraw from interfering with the upright members 456, 462. A user can then lift the moveable rail assembly 450, for example by the top rail 452 or the handles 453 extending from the top rail 452 up away and from the base 302. When the moveable rail assembly 450 reaches the extended position, apertures 472 in one or more of the upright members 456, 458, 460, and/or 462 align with the spring pins 470 and/or 476, respectively, such that the biased spring pins 470, 476 extend into the apertures 472 and lock the moveable rail assembly in the extended position shown in FIG. 18. To lower the moveable rail assembly 450, a user first pulls each rear spring pin 470 from the extended position to the retracted position and locks the spring pin 470 in the retracted position by rotating the knob of each spring pin 470. Then the user rotates the handle 474 to release the rear spring pins 476, freeing the moveable rail assembly 450. The moveable rail assembly 450 is then lowered until the spring pins 470, 476 engage again with apertures 472 proximate the top rail 452 to secure the moveable rail assembly in the normal position shown in FIG. 19

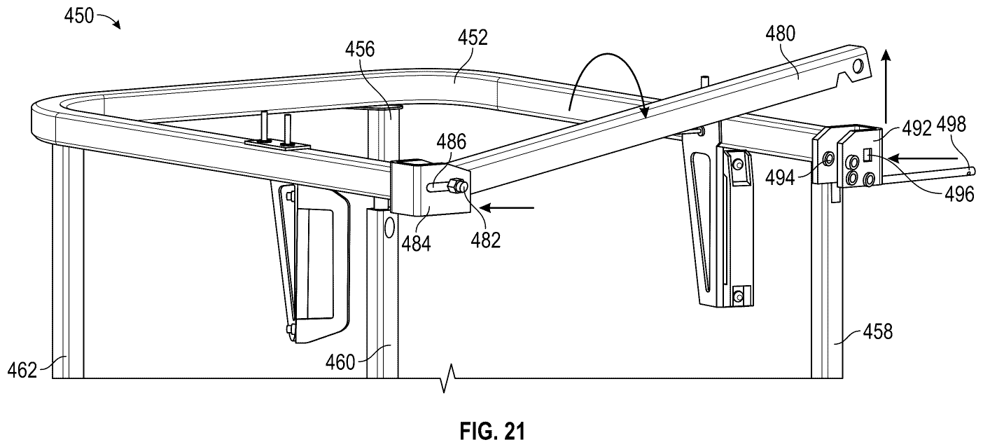

Referring now to FIGS. 20 and 21, a gate 480 for the moveable rail assembly 450 is shown. The gate 480 is rotatably coupled to the top rail 452 and/or the upright members and extends across the base 302 from upright member 460 and is moveable between an open position as shown in FIG. 20 and a closed position. The gate 480 is rotatably coupled to the moveable rail assembly 450 by a bracket 484 with a slot 486. Extending through the slot is a pin 482 (e.g., a stud) fixedly coupled to the gate 480. The pin 482 within the slot 486 allows the gate 480 to both rotate up wards the top rail 452 and to extend out away from the upright member 460 towards the upright member 458 when moving to the closed position as shown in FIG. 21. The gate 480 couples proximate the upright member 456 by a bracket 492 which includes a pin 494 extending across the bracket 492. A recess 488 in a free end of the gate 480 receives the pin 494 of the bracket 492 and supports the gate 480 on the bracket 4892. The gate 480 may also be secured in this closed position by a retention pin 498 which extends through a retention hole 496 of the bracket 492 into the gate 480 through aperture 490. The retention pin 498 can then be removed, the gate 480 lifted, the gate 480 pushed back towards the upright member 460 by translating the pin 482 through the slot 486, and then let fall into the open position.

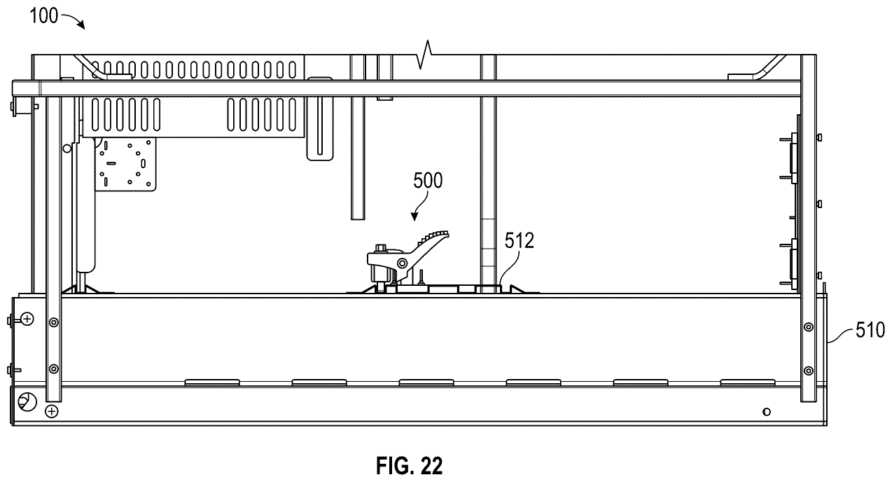

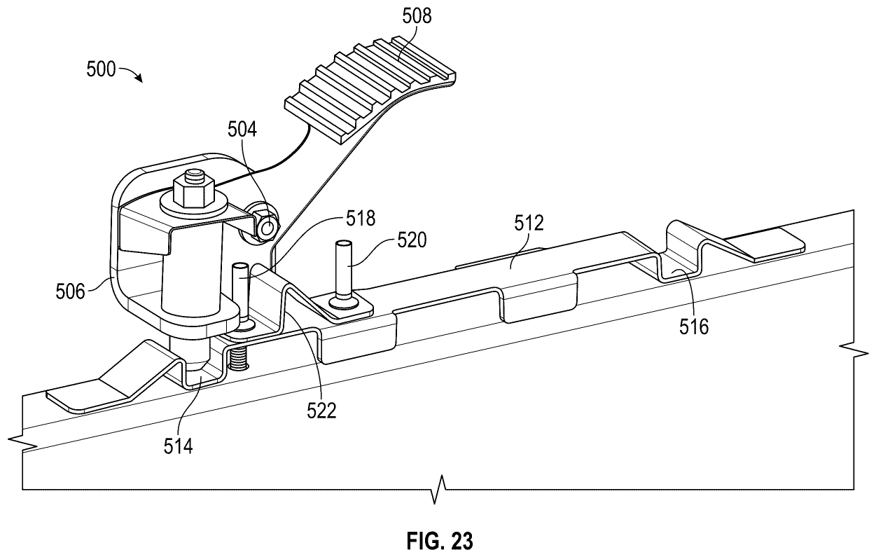

Referring now to FIGS. 1, 22 and 23, the extendable platform 300 also includes a stopping mechanism for controlling the movement of the extendable platform 300 relative to the rest of platform 100, shown as extension control system 500. The extension control system 500 includes a post 502 extending from and away the base 302 proximate the wall 306. At a top of the wall 306 is a lever 508 that is rotatable about the pivot point 504. On one end of the lever is a pin 506. Referring now specifically to FIGS. 22 and 23, the pin 506 engages with a guide 512 on top of wall 510 of the platform 100. The wall 306 translates relative to the wall 510, which moves the post 502, pin 506, and lever 508 along the guide 512. The guide 512 includes one or more recesses shown as recesses 514, 516. One or both of recesses 514, 516 receive the pin 506 and act as stops to limit further extension of the extendable platform 300 relative the rest of the platform 100. The stops may include a middle stop and a rear stop. In some embodiments, a rivet 518 is added which limits the pin 506 to engagement only with the recess 514. There may be additional rivets such as rivet 520 to provide a stop in the reverse direction. A ramp 522 on the guide 512 can further protect against the pin 506 slipping out of the recess 514.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device platforms and decks as shown in the various exemplary embodiments are illustrative only. Additionally, any element disclosed in one embodiment may be incorporated or utilized with any other embodiment disclosed herein.

What is claimed is:

1. A platform for a lift device, the platform comprising:
a base;
a plurality of rails at least partially surrounding the base; and
a deck selectively coupled to the plurality of rails and moveable between a storage position and a use position, the deck comprising:
a front side opposite a back side;
a first lateral side and a second lateral side opposite the first lateral side, the lateral sides extending between the front side and the back side; and
a locking mechanism configured to secure the deck in at least one of the storage position or the use position;
wherein in the storage position, the deck is substantially perpendicular with the base and in the use position, the deck is substantially parallel with the base.

2. The platform of claim 1, wherein the plurality of rails comprises at least one handrail extending away from the base, the at least one handrail comprising:
an open end proximate the base; and
a closed end opposite the open end.

3. The platform of claim 1, wherein the deck further comprises:
a pair of flanges coupled at each of the lateral sides proximate the back side of the deck; and
a pair of channels coupled to the base at the lateral sides of the deck, the channels configured to selectively receive the flanges,
wherein moving the deck from the storage position to the use position includes translating the flanges within the channels in a vertical direction and pivoting the deck around an axis defined by a pair of spring pins.

4. The platform of claim 3, wherein the locking mechanism comprises:
a pair of spring pins at each of the lateral sides proximate the front side of the deck and moveable between an extended position and a retracted position;
a cam rotatably coupled to a bottom surface of the deck and coupled to each of the spring pins to move the spring pins between the extended and retracted positions; and
a release rod coupled at one end to the cam and terminating in a release rod handle at an end of the release rod,
wherein in the retracted position, the deck is vertically translatable within the channels, and in the extended position, the spring pins are biased such that vertical translation of the deck is prevented.

5. The platform of claim 4, wherein the release rod is configured to rotate the cam to move the spring pins between the extended and the retracted positions, wherein in the extended position, the spring pins are retained in apertures and in the retracted position, the spring pins are withdrawn from the apertures.

6. The platform of claim 4, wherein the deck further comprises a handle proximate to the release rod handle and coupled to the back side of the deck.

7. The platform of claim 1, further comprising an extendable rail assembly comprising:
a plurality of guides coupled to the plurality of rails;
a plurality of upright members extending within the plurality of guides away from the base; and
a top rail extending between the plurality of upright members, wherein each of the plurality of upright members comprises at least one first aperture proximate an end of the plurality of upright members and at least one second aperture between the at least one first aperture and the top rail, wherein the plurality of upright members and the top rail form a moveable rail assembly.

8. The platform of claim 7, wherein the moveable rail assembly is moveable between a retracted position and one or more extended positions, and the extendable rail assembly further comprises a rail lock mechanism configured to secure the moveable rail assembly in the retracted position and the one or more extended positions.

9. The platform of claim 8, wherein the rail lock mechanism comprises:
a second pair of spring pins coupled to the plurality of rails;
wherein when moving into the extended position, the second pair of spring pins automatically engage the at least one second aperture to lock the moveable rail assembly in the extended position.

10. The platform of claim 7, further comprising a gate rotatably coupled to at least one of the extendable rail assembly and moveable between an open position and a closed position, wherein in the closed position the top rail and the gate form a perimeter rail.

11. The platform of claim 10, wherein the extendable rail assembly further comprises:
a first bracket rotatably coupling a first end of the gate with the extendable rail assembly; and
a second bracket coupled with the extendable rail assembly and configured to support the gate, the second bracket including a pin.

12. The platform of claim 11, wherein moving the gate between the open position and the closed position includes the pin receiving a recess of the second end of the gate, opposite the first end.

13. A lift device comprising:
a chassis;
a lift assembly coupled to the chassis; and
a platform coupled with the lift assembly, the platform comprising:
a base;
a plurality of rails at least partially surrounding the base; and
a deck selectively coupled to the plurality of rails and moveable between a storage position and a use position, the deck comprising:
a front side opposite a back side;
a first lateral side and a second lateral side opposite the first lateral side, the lateral sides extending between the front side and the back side; and
a locking mechanism configured to secure the deck in at least one of the storage position or the use position;
wherein in the storage position, the deck is substantially perpendicular with the base and in the use position, the deck is substantially parallel with the base.

14. The lift device of claim 13, wherein the deck further comprises an extension control system configured to limit movement of the platform, the extension control system comprising:
a lever coupled to the platform at a first end extending away from the base;
a pin coupled to a second end of the lever opposite the first end; and
a guide coupled to a top end of the platform and comprising a first recess and a second recess;
wherein at least one of the first recess and the second recess are configured to receive the pin and provide a stop.

15. The lift device of claim 14, the extension control system further comprising a rivet coupled to the guide between the first recess and the second recess preventing the lever from moving between the first recess and the second recess.

16. The lift device of claim 13, wherein the deck further comprises:
a pair of flanges coupled at each of the lateral sides proximate the back side of the deck; and
a pair of channels coupled to the base at the lateral sides of the deck, the channels configured to selectively receive the flanges,
wherein moving the deck from the storage position to the use position includes translating the flanges within the channels in a vertical direction and pivoting the deck around an axis defined by a pair of spring pins.

17. The lift device of claim 16, wherein the locking mechanism comprises:
a pair of spring pins at each of the lateral sides proximate the front side of the deck and moveable between an extended position and a retracted position;
a cam rotatably coupled to a bottom surface of the deck and coupled to each of the spring pins to move the spring pins between the extended and retracted positions; and
a release rod coupled at one end to the cam and terminating in a release rod handle at an end of the release rod,
wherein in the retracted position, the deck is vertically translatable within the channels, and in the extended position, the spring pins are biased such that vertical translation of the deck is prevented.

18. The lift device of claim 15, further comprising an extendable rail assembly comprising:
a plurality of guides coupled to the plurality of rails;
a plurality of upright members extending within the plurality of guides away from the base; and
a top rail extending between the plurality of upright members, wherein each of the plurality of upright members comprises at least one first aperture proximate an end of the plurality of upright members and at least one second aperture between the first aperture and the top rail, wherein the plurality of upright members and the top rail form a moveable rail assembly.

19. The lift device of claim 18, wherein the moveable rail assembly is moveable between a retracted position and one or more extended positions, and the extendable rail assembly further comprises a rail lock mechanism configured to secure the moveable rail assembly in the retracted position and the one or more extended positions.

20. A deck assembly for a platform, the deck assembly comprising:
a deck selectively coupled to the platform and moveable between a storage position and a use position, the deck comprising:
a front side opposite a back side;
a first lateral side and a second lateral side opposite the first lateral side, the lateral sides extending between the front side and the back side;
a locking mechanism configured to secure the deck in at least one of the storage position or the use position;
a pair of flanges coupled at each of the lateral sides proximate the back side of the deck;
a pair of channels at the lateral sides of the deck, the channels configured to selectively receive the flanges;
a pair of spring pins at each of the lateral sides proximate the front side of the deck and moveable between an extended position and a retracted position, wherein in the retracted position, the deck is vertically translatable within the channels; and
a cam rotatably coupled to a bottom surface of the deck and coupled to each of the spring pins to move the spring pins between the extended and retracted positions;
wherein moving the deck from the storage position to the use position includes translating the flanges within the channels in a vertical direction and pivoting the deck around an axis defined by the pair of spring pins.
